(19) United States
(12) Patent Application Publication
(10) Pub. No.: US 2009/0010265 A1
(43) Pub. Date: Jan. 8, 2009

(54) Flexible mapping of virtual local area networks to Ethernet virtual circuits

(75) Inventors: Phanilatha Vishnubhotla, San Jose, CA (US); Chiara Regale, Santa Clara, CA (US)

Correspondence Address: ABELMAN, FRAYNE & SCHWAB, 666 THIRD AVENUE, 10TH FLOOR, NEW YORK, NY, 10017, US

(73) Assignee: Cisco Technology, Inc.

(21) Appl. No.: 11/825,338

(22) Filed: Jul. 5, 2007

(51) Int. Cl. H04L 12/28

(52) U.S. Cl. 370/395.53

(57) ABSTRACT

A method includes configuring multiple Ethernet Virtual Circuits (EVCs) for communicating with respective service gateways that provide respective communication services. A data packet, which belongs to a Virtual Local Area Network (VLAN) and is associated with a communication service from among the communication services, is accepted. The data packet is mapped to an EVC from among the multiple EVCs responsively to the VLAN to which the data packet belongs and to the communication service with which the data packet is associated. The data packet is sent over the EVC to the service gateway, in order to provide the communication service.

### FIELD OF THE INVENTION

The present invention relates generally to communication networks, and particularly to methods and systems for aggregation and routing of Virtual Local Area Networks (VLAN).

### BACKGROUND OF THE INVENTION

Communication service providers often provide communication services such as voice, video and data to their subscribers over data communication networks. In many networks, the services and/or subscribers are provisioned using Virtual Local Area Networks (VLANs). VLANs are defined in the IEEE 802.1Q™ standard, 2005 edition, entitled “IEEE Standard for Local and Metropolitan Area Networks—Virtual Bridged Local Area Networks,” May, 2006, which is incorporated herein by reference.

In some access network configurations, the traffic of multiple subscribers is aggregated using Digital Subscriber Line Access Multiplexers (DSLAMs), and then transported to Service Gateways (SGWs), Application Servers (ASs) or other destinations over Ethernet™ Virtual Circuits (EVCs). EVCs are described, for example, By Santitoro in a white paper published by the Metro Ethernet Forum (MEF) entitled “Metro Ethernet Services—a Technical Overview,” 2006, which is incorporated herein by reference. An EVC, as defined by the MEF, is a connection between two User-to-Network Interfaces (UNIs), or sites, which enables the transfer of Ethernet frames between them. EVCs typically comprise port-level layer-2 circuits that provide end-to-end virtual connectivity.

EVCs may be formed using different encapsulation or tunneling protocols, such as Ethernet™ over Multi-Protocol Label Switching (EoMPLS), Layer Two Tunneling Protocol version 3 (L2TPv3) and Generic Routing Encapsulation (GRE). EOMPLS is defined by Martini et al., in Request For Proposal 4448 of the Internet Engineering Task Force (IETF RFC 4448), entitled “Encapsulation Methods for Transport of Ethernet over MPLS Networks,” April, 2006, which is incorporated herein by reference. This RFC, as well as other RFCs cited below, are available at www.ietf.org/rfc. The L2TPv3 protocol is described by Lau et al., in IETF RFC 3931, entitled “Layer Two Tunneling Protocol—Version 3 (L2TPv3),” March, 2005, which is incorporated herein by reference. The GRE protocol is described by Farinacci et al., in IETF RFC 2784, entitled “Generic Routing Encapsulation (GRE),” March, 2000, which is incorporated herein by reference.

Transporting VLAN traffic over EVCs usually involves mapping data packets to EVCs based on the VLANs to which the packets belong. Methods for mapping of VLANs to EVCs are described, for example, in a technical specification published by the Metro Ethernet Forum, entitled “Technical Specification, MEF 1, Ethernet Services Model, Phase 1,” Nov. 10, 2003, which is incorporated herein by reference. The MEF1 specification defines a one-to-one mapping method, in which each VLAN is mapped to a separate EVC, and an all-to-one bundling method, in which all VLANs are mapped to a single EVC. Alternative methods that can be used for transporting VLAN traffic over virtual circuits are described in the IEEE 802.1AD-D6.0 draft standard, entitled “Draft Standard for Local and Metropolitan Area Networks—Virtual Bridged Local Area Networks—Amendment 4: Provider Bridges,” August, 2005, which is incorporated herein by reference.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a communication network, in accordance with an embodiment of the present invention; and

FIG. 2 is a flow chart that schematically illustrates a method for mapping VLANs to EVCs, in accordance with an embodiment of the present invention.

### DESCRIPTION OF EXAMPLE EMBODIMENTS

### Overview

Embodiments of the present invention that are described herein provide improved methods and systems for mapping VLANs to EVCs. In some of these embodiments, a communication network includes a number of Service Gateways (SGWs) that provide respective communication services to network subscribers. The subscribers consume these services by exchanging data packets with the network. The subscribers are provisioned so that each subscriber, and sometimes each individual service, is assigned a VLAN. Thus, each data packet sent by a subscriber is associated with a certain service and belongs to a certain VLAN.

The network comprises a Provider Edge (PE) access device, which accepts the data packets and forwards each packet to the appropriate SGW, i.e., to the SGW that provides the service with which the packet is associated. An EVC is configured for transporting data packets between the PE access device and each of the SGWs. The PE access device determines the EVC over which to send each data packet using a flexible and configurable mapping configuration. The mapping configuration maps packets to EVCs based on the VLAN to which the packet belongs. In some embodiments, the PE access device has multiple access ports over which the packets arrive (e.g., from multiple DSLAMS), and the mapping configuration also considers the identity of the access port over which the packet arrives. Additionally or alternatively, the mapping configuration may also consider a Quality of Service (QoS) rating assigned to the data packet. The PE access device sends each data packet to the appropriate SGW over the EVC determined by the mapping configuration.

Unlike some known mapping methods in which each VLAN (i.e., subscriber or individual service) is mapped to a separate EVC, the number of EVCs used in the methods and systems described herein depends on the number of SGWs and not on the number of VLANs. As a result, the management overhead and processing complexity associated with handling a large number of EVCs is considerably reduced. The methods and systems described herein thus provide a high degree of service scalability, i.e., an ability to handle a growing number of subscribers and services with only modest growth in complexity and overhead.

On the other hand, unlike other known mapping methods in which all VLANs that arrive over a certain access port are mapped to the same EVC, the methods and systems described herein enable complete flexibility: VLANs arriving from different access ports (different DSLAMS) can be mapped to the same EVC, and VLANs arriving on a certain access port can be mapped to multiple EVCs. Thus, when using the methods and systems described herein, a service provider can use a single DSLAM for aggregating traffic from different types of subscribers that use different services offered by different SGWs. The aggregated traffic provided by this DSLAM can then be mapped and distributed by the PE access device to the appropriate destinations. The ability to aggregate different types of subscribers and services in a single DSLAM (e.g., mixing residential and business subscribers) provides significant operational flexibility and cost reduction to the service provider. Moreover, mapping traffic originating from different types of subscribers to the appropriate destinations at the entry point to the network improves the ability to comply with the Service Level Agreements (SLAs) defined for the different subscriber types.

### System Description

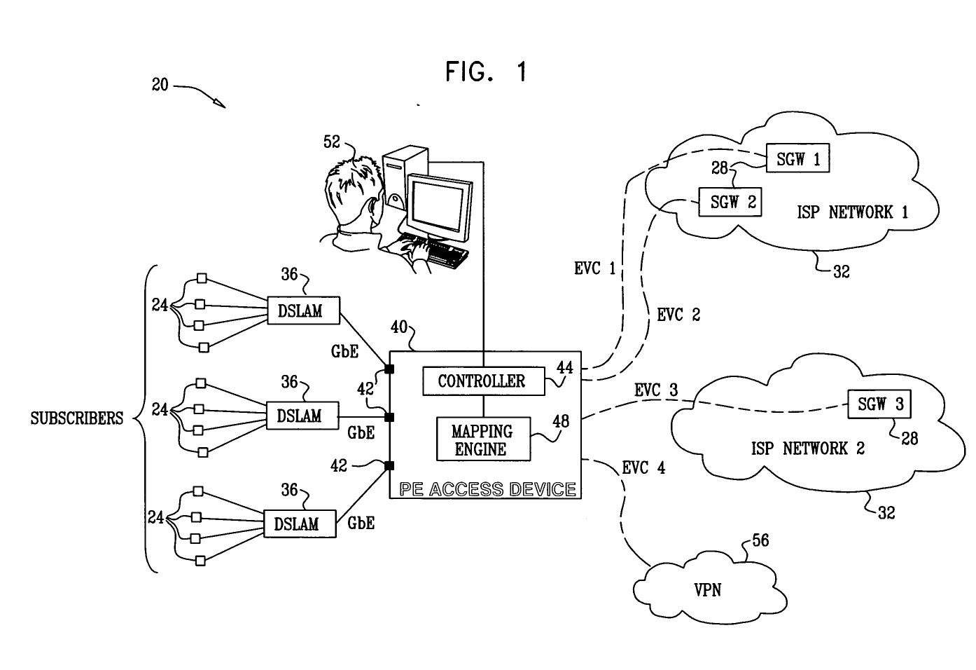

FIG. 1 is a block diagram that schematically illustrates a communication network 20, in accordance with an embodiment of the present invention. Network 20 provides communication services to multiple subscribers 24, which may comprise residential subscribers, business subscribers or any other type of subscribers. The communication services consumed by subscribers 24 may comprise, for example, voice and/or video telephony, data communication, Internet access, television services such as streaming video or video on demand (VOD) and/or any other suitable communication service. In some cases, the subscribers are provided with a “triple play” package, i.e., a bundled service package comprising telephony, Internet access and television.

Network 20 comprises various service gateways (SGWs) 28, which provide the different services to subscribers 24. In the context of the present patent application and in the claims, the term “service gateway” is used to describe any and all types of computing platforms that provide communication services. Such platforms may comprise, for example, various Application Servers (ASs), video and multimedia servers, Voice over IP (VoIP) servers, as well as gateways to other networks external to network 20. In some embodiments, some SGWs may be operated by different service providers and reside in different service provider networks 32. For example, in the configuration of FIG. 1, two SGWs are located in one provider network, and a third SGW resides in a different provider network.

Network 20 typically comprises an Internet Protocol (IP) network, and traffic is exchanged between subscribers 24 and SGWs 28 using data packets. The connections with subscribers 24 are provisioned by associating each subscriber or service with a certain Virtual Local Area Network (VLAN).

Two provisioning models are commonly used. In some network configurations, each subscriber is assigned a unique VLAN. Different services consumed by the same subscriber are assigned the same VLAN, and are differentiated from one another by a Quality-of-Service (QoS) tag. For example, voice, video, best-effort data and high-priority data services used by a given residential user will be assigned the same VLAN but different QoS tags. In some cases, the QoS tag reflects the Service Level Agreement (SLA) associated with the service. This model is commonly referred to as a VLAN-per-subscriber model. Since the range of valid VLANs defined in the IEEE 802.1Q standard is limited to 4,096, this provisioning model supports up to 4,096 subscribers.

Other network configurations use a VLAN-per-service model, in which each individual service is assigned a unique VLAN. In this model, voice, data and video services used by a particular user will be assigned three different VLANs. This provisioning model supports a smaller number of subscribers in comparison with the VLAN-per-subscriber model. For example, when each subscriber uses four different services, only up to 1,024 subscribers can be supported.

The traffic to and from subscribers 24 is aggregated using multiple Digital Subscriber Line Access Multiplexers (DSLAMs) 36. Each DSLAM 36 aggregates the traffic of multiple subscribers onto a Gigabit Ethernet (GbE) interface. Each DSLAM can aggregate up to 4,096 VLANs.

The multiple GbE interfaces are aggregated by a Provider Edge (PE) access device 40, which comprises multiple access ports 42, each port connected to a respective DSLAM. Device 40 can thus terminate up to 4,096 VLANs per access port. Each data packet arriving at device 40 originates from a certain subscriber and is associated with a certain service that the subscriber consumes. The data packet is thus identified by a particular VLAN, and possibly by a QoS tag that indicates the QoS rating assigned to the service, in accordance with the provisioning model used. In order to provide the appropriate services to each subscriber, device 40 forwards each incoming data packet to the SGW that provides the service to which the packet belongs. PE access device 40 forwards the data packets to the appropriate SGWs by mapping the packets to Ethernet Virtual Circuits (EVCs). As can be seen in FIG. 1, a single EVC is defined between device 40 and each SGW 28. In some embodiments, an EVC may connect device 40 with a Virtual Private Network 56, such as for providing VPN services to business subscribers. In the context of the present patent application and in the claims, the term “virtual circuit” is used to describe any type of logical path or connection via network 20, over which data packets can be exchanged. For example, the EVCs may be formed using various encapsulation and tunneling protocols, such as the Ethernet over Multi-Protocol Label Switching (EOMPLS) protocol, Layer Two Tunneling Protocol version 3 (L2TPv3) and Generic Routing Encapsulation (GRE) protocol, cited above.

Device 40 accepts the data packets that arrive from subscribers 24 via DSLAMS 36, extracts the individual packets from the aggregated packet streams, determines the appropriate destination SGW for each packet, and forwards the packet to the SGW over the corresponding EVC. Device 40 determines the EVC for each packet using a flexible mapping configuration, which maps the VLAN to which the packet belongs, and optionally the QoS tag carried by the packet, to one of the predefined EVCs.

The mapping of VLANs to EVCs is usually pre-configured by an operator 52, such as a network administrator. Device 40 comprises a controller 44, which interacts with the operator via a suitable interface and accepts the mapping configuration. Device 40 further comprises a mapping engine 48, which accepts the incoming data packets from access ports 42, maps each packet to the appropriate EVC in accordance with the mapping configuration, formats the packet accordingly and forwards the packet over the EVC to the destination SGW.

Typically, mapping engine 48 is implemented using hardware or firmware and processes the incoming packets in real time. The functions of controller 44 may be implemented in software, hardware or as a combination of hardware and software elements. Typically, controller 44 comprises a general-purpose processor, which is programmed in software to carry out the functions described herein. The software may be downloaded to the processor in electronic form, over a network, for example, or it may alternatively be supplied to the computer on tangible media, such as CD-ROM.

In some embodiments, the functionality of device 40 can be embodied in a known network edge router or other Provider Edge (PE) device. For example, Cisco Systems, Inc. (San Jose, Calif.) offers the Catalyst 6500 series switches and the 7600 series routers, which can be used for this purpose. Details regarding these products are available at www.cisco.com/en/US/products/hw/switches/ps708/index.html and www.cisco.com/en/US/products/hw/routers/ps368/index.html, respectively.

### Exemplary Mapping Configurations

PE access device 40 can use various kinds of mapping configurations. In some embodiments, the mapping configuration is stored in a table or other data structure in device 40. For example, mapping engine 48 may comprise a configurable look-up table, which is indexed by the VLAN (or VLAN and QoS tag) of the packet and by the access port over which the packet was accepted, and outputs the identity of the appropriate EVC.

For example, consider a network configuration in which device 40 comprises two access ports 42 connected to two respective DSLAMS 36. The first DSLAM aggregates multiple residential subscribers using VLANs 1-4000, and a business subscriber using VLAN 4030. The second DSLAM aggregates other residential subscribers using VLANs 1-4000, and another business subscriber (different from the business subscriber handled by the first DSLAM) using VLAN 4030. The residential subscribers are provided with triple-play services by three SGWs, wherein SGW1 provides voice telephony services, SGW2 provides video services and SGW3 provides Internet access. The business subscriber is provided a VPN service.

The following table defines an exemplary mapping configuration, which assumes VLAN-per-subscriber provisioning (i.e., mapping by VLAN and QoS tag):

| DSLAM | | | | |
|---|---|---|---|---|
| (Access | | | | |
| port) | VLAN | QoS tag | EVC ID | Destination |
| 1 | 1-4000 | Voice | 1 | SGW1 |
| | 1-4000 | Video | 2 | SGW2 |
| | 1-4000 | Internet | 3 | SGW3 |
| | | access | | |
| | 4030 | VPN | 4 | VPN |
| 2 | 1-4000 | Voice | 1 | SGW1 |
| | 1-4000 | Video | 2 | SGW2 |
| | 1-4000 | Internet | 3 | SGW3 |
| | | access | | |
| | 4030 | VPN | 4 | VPN |

Each QoS tag may correspond to a different SLA. Therefore, the mapping of packets to EVCs can be based on the SLA defined for the packet.

Alternatively, when VLAN-per-service provisioning is used, the mapping configuration can use the following table:

| DSLAM | | | |
|---|---|---|---|
| (Access | | | |
| port) | VLAN | EVC ID | Destination |
| 1 | 1-1000 | 1 | SGW1 |
| | 1001-2000 | 2 | SGW2 |
| | 2001-4000 | 3 | SGW3 |
| | 4030 | 4 | VPN |
| 2 | 1-1000 | 1 | SGW1 |
| | 1001-2000 | 2 | SGW2 |
| | 2001-4000 | 3 | SGW3 |
| | 4030 | 4 | VPN |

This mapping configuration assumes that in each DSLAM, VLANs 1-1000 are allocated to voice services, VLANs 1001-2000 are allocated to video services and VLANs 2001-4000 are allocated to Internet access services. In this case, the SLA of the packets is taken into account implicitly, since packets having different SLAs are allocated different VLANs.

The exemplary mapping configurations described above demonstrate several features of the methods described herein. For example, unlike some known mapping methods in which each VLAN is mapped to a separate EVC, the number of EVCs used in the disclosed methods depends on the number of SGWs and not on the number of VLANs. As a result, the management overhead and processing complexity associated with handling a large number of EVCs is considerably reduced. The methods and systems described herein thus provide a high degree of service scalability, i.e., an ability to handle a growing number of subscribers and services with only modest growth in complexity and overhead.

Unlike other known mapping methods in which all VLANs that arrive over a certain access port are mapped to the same EVC, the methods and systems described herein enable complete flexibility: VLANs arriving from different access ports (different DSLAMS) can be mapped to the same EVC, and VLANs arriving on a certain access port can be mapped to multiple EVCs. Thus, when using the methods and systems described herein, a service provider can use a single DSLAM for aggregating traffic from different types of subscribers that use different services offered by different SGWs. The aggregated traffic provided by this DSLAM can then be mapped and distributed by device 40 to the appropriate destinations. The ability to aggregate different types of subscribers and services in a single DSLAM (e.g., mixing residential and business subscribers) provides significant operational flexibility and cost reduction to the service provider.

The mapping configurations described above are exemplary configurations, which were chosen purely for the sake of conceptual clarity. In alternative embodiments, any other suitable mapping configuration can also be used. For example, VLANs can be allocated to subscribers and/or services either in contiguous or non-contiguous ranges.

### Mapping Method Description

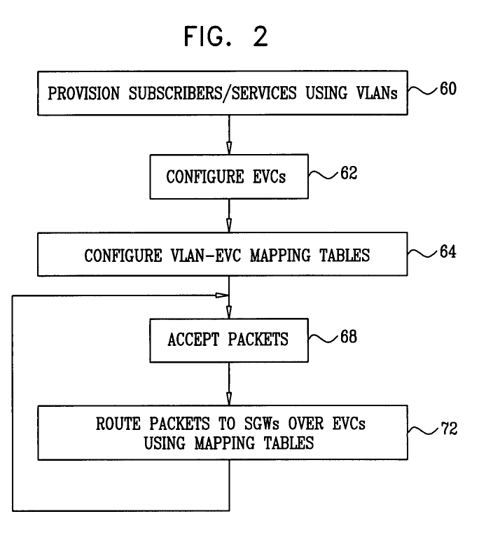

FIG. 2 is a flow chart that schematically illustrates a method for mapping VLANs to EVCs, in accordance with an embodiment of the present invention.

The method begins with a network administrator or designer assigning VLANs to subscribers 24, and possibly to the individual services they use, at a provisioning step 60. The provisioning process can use the VLAN-per-subscriber model, the VLAN-per-service model, or any other suitable provisioning model. The administrator configures EVCs that connect device 40 with each of SGWs 28, at an EVC configuration step 62. As noted above, the EVCs may be formed using EOMPLS, L2TPv3, GRE or any other suitable protocol.

The administrator defines a mapping configuration, such as the mapping tables described above, at a mapping definition step 64. The mapping configuration maps VLAN tags to EVCs, so that incoming data packets can be mapped to the appropriate EVCs. In some embodiments, the mapping configuration may also consider the QoS tags carried by the packets and/or the identity of the access port over which the packets arrived.

During operation of network 20, PE access device 40 accepts data packets, which were sent by subscribers 24 and aggregated by DSLAMS 36, at a packet acceptance step 68. Each data packet is associated with a certain service, which is provided by one of SGWs 28. Each data packet belongs to a certain VLAN, in accordance with the way the originating subscriber was provisioned at step 60 above. As such, the packet header comprises a VLAN tag whose value identifies the packet with the VLAN. The packet header may also comprise a QoS tag, which identifies the service with which the packet is associated.

Device 40 sends each data packet over the appropriate EVC to the SGW that provides the service with which the packet is associated, at a forwarding step 72. Device 40 extracts each data packet from the stream of aggregated data packets provided by the DSLAM, and determines the EVC over which to send each data packet using the mapping configuration defined at step 64 above, based on the VLAN tag of the packet. Depending on the mapping configuration, device 40 may additionally base the mapping decision on the QoS tag of the packet and/or the identity of the access port over which the packet arrived (i.e., the identity of the DSLAM that sent the packet).

Although in FIG. 2 the definition and configuration process of steps 60-64 is carried out a-priori, i.e., before packets are received and processed, these definitions can be modified during operation of device 40 and of network 20 in general. For example, subscribers and services can be added or deleted, VLAN assignments can be modified, and EVCs can be added, deleted or reconfigured during operation.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method, comprising:
configuring multiple Ethernet Virtual Circuits (EVCs) for communicating with respective service gateways that provide respective communication services;
accepting a data packet, which belongs to a Virtual Local Area Network (VLAN) and is associated with a communication service from among the communication services;
mapping the data packet to an EVC from among the multiple EVCs responsively to the VLAN to which the data packet belongs and to the communication service with which the data packet is associated; and
sending the data packet over the EVC to the service gateway, in order to provide the communication service.

2. The method according to claim 1, wherein configuring the EVCs comprises establishing one of Ethernet over
Multi-Protocol Label Switching (EOMPLS) tunnels, Layer Two Tunneling Protocol version 3 (L2TPv3) tunnels and Generic Routing Encapsulation (GRE) tunnels for communicating with the respective service gateways.

3. The method according to claim 1, wherein the data packet originates from a subscriber, and wherein the VLAN uniquely identifies the subscriber irrespective of the communication service.

4. The method according to claim 1, wherein the data packet originates from a subscriber, and wherein the VLAN uniquely identifies a combination of the subscriber and the communication service.

5. The method according to claim 1, wherein the data packet is accepted over an access port within a plurality of access ports, and wherein mapping the data packet to the EVC comprises selecting the EVC responsively to an identity of the access port from which the data packet was accepted.

6. The method according to claim 1, wherein the data packet has a Quality-of-Service (QoS) rating, and wherein mapping the data packet to the EVC comprises selecting the EVC responsively to the QoS rating of the packet.

7. The method according to claim 1, wherein the service gateways reside in at least two different provider networks.

8. The method according to claim 1, wherein accepting the data packet comprises accepting a stream of aggregated data packets, and extracting the data packet from the stream.

9. A communication apparatus, comprising:
a configuration interface, which is arranged to accept a mapping configuration between Virtual Local Area Networks (VLANs) and multiple Ethernet Virtual Circuits (EVCs) that connect the device to respective service gateways that provide respective communication services; and
a mapping engine, which is operative to accept a data packet, which belongs to a VLAN from among the VLANs and is associated with a communication service from among the communication services, to map the data packet to an EVC from among the EVCs responsively to the VLAN to which the data packet belongs and to the communication service with which the data packet is associated in accordance with the mapping configuration, and to send the data packet over the EVC to the service gateway.

10. The apparatus according to claim 9, wherein the EVCs comprise one of Ethernet over Multi-Protocol Label Switching (EOMPLS) tunnels, Layer Two Tunneling Protocol version 3 (L2TPv3) tunnels and Generic Routing Encapsulation (GRE) tunnels, which connect the apparatus with the respective service gateways.

11. The apparatus according to claim 9, wherein the data packet originates from a subscriber, and wherein the VLAN uniquely identifies the subscriber irrespective of the communication service.

12. The apparatus according to claim 9, wherein the data packet originates from a subscriber, and wherein the VLAN uniquely identifies a combination of the subscriber and the communication service.

13. The apparatus according to claim 9, and comprising a plurality of access ports coupled to the mapping engine, wherein the mapping engine is arranged to accept the data packet from an access port from among the access ports, and to select the EVC responsively to an identity of the access port from which the data packet was accepted.

14. The apparatus according to claim 9, wherein the data packet has a Quality-of-Service (QoS) rating, and wherein the mapping engine is arranged to select the EVC responsively to the QoS rating of the packet.

15. The apparatus according to claim 9, wherein the service gateways reside in at least two different provider networks.

16. The apparatus according to claim 9, wherein the mapping engine is arranged to accept a stream of aggregated data packets and to extract the data packet from the stream.

17. A communication apparatus, comprising:
means for configuring multiple Ethernet Virtual Circuits (EVCs) for communicating with respective service gateways that provide respective communication services;
means for accepting a data packet, which belongs to a Virtual Local Area Network (VLAN) and is associated with a communication service from among the communication services;
means for mapping the data packet to an EVC from among the multiple EVCs responsively to the VLAN to which the data packet belongs and to the communication service with which the data packet is associated; and
means for sending the data packet over the EVC to the service gateway, in order to provide the communication service.

18. The apparatus according to claim 17, wherein the data packet originates from a subscriber, and wherein the VLAN uniquely identifies the subscriber irrespective of the communication service.

19. The apparatus according to claim 17, wherein the data packet originates from a subscriber, and wherein the VLAN uniquely identifies a combination of the subscriber and the communication service.

20. The apparatus according to claim 17, wherein the means for mapping the data packet to the EVC comprise means for selecting the EVC responsively to at least one parameter selected from a group of parameters consisting of an identity of a port from which the data packet was accepted and a Quality-of-Service (QoS) rating of the data packet.
